(19) United States
(12) Patent Application Publication
(10) Pub. No.: US 2026/0080333 A1
(43) Pub. Date: Mar. 19, 2026

(54) INTERACTIVE SPECULATIVE PLANNING

(71) Applicant: Microsoft Technology Licensing, LLC, Redmond, WA (US)

(72) Inventors: Jagannath Shashank Subramanya Sai VADREVU, Kanata (CA); Mengting WAN, Kirkland, WA (US); Ryan Martin NADEL, Vancouver (CA); Chi WANG, Medina, WA (US); Wenyue HUA, North Brunswick, NJ (US)

(21) Appl. No.: 18/886,726

(22) Filed: Sep. 16, 2024

(51) Int. Cl. G06Q 10/0631; G06F 9/38

(52) U.S. Cl. CPC G06Q 10/06316; G06F 9/3885

(57) ABSTRACT

The present disclosure generally relates to employing an interactive speculative planning system to complete a plan and execute the steps of a requested task. Systems described herein implement a fast approximation agent and an accurate target agent to generate action steps in response to receiving a request to complete a task. For each task, the approximation agent generates action steps sequentially. Simultaneously, for every step the approximation agent produces, the described system calls the target agent asynchronously to generate the next step, using the current trajectory from the approximation agent as a provisional prefix. For each action step, if the outputs of the approximation agent and the target agent match, the described system continues the process. However, if there is a mismatch, the described system halts the approximation agent, and replaces its output with the target agent's output to ensure performance is not compromised.

### BACKGROUND

Large language models (LLMs) and other generative artificial intelligence (AI) models have demonstrated strong reasoning abilities, enabling them to plan and interact with a large corpus of tools and applications. This has led to the development of LLM-based agents to enhance the capabilities of LLMs and other models and have become an increasingly common tool for task delegation, assisting with a wide range of requests by generating responses, interacting with user proxies, and producing final action plans. For example, LLMs (and other generative AI models) and LLM-based agents are currently employed to perform a wide variety of multi-step tasks.

While LLM agents provide helpful tools in processing these multi-step tasks, LLM agents often experience significant computational shortcomings and inefficiencies. For example, LLM agents frequently experience significant latency. This increased latency is typically a result of two factors: the efficiency constraints of the underlying LLMs-exacerbated by their large size and high demand, and the structural complexity of the final output. Indeed, due to the computationally robust nature of LLMs, many LLMs experience long running times on one or multiple LLM calls. Additionally, many LLM-based agents are structurally complex because they usually need to generate long “thought-process” lines of text before generating the final outcome. This leads to long wait times for each single step in task planning. Also, as task planning usually requires multiple steps, this also leads to long wait times as the sequential calls for the LLM-based agents are generally difficult to parallelize.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### BRIEF DESCRIPTION OF THE DRAWINGS

FIG. 1 illustrates an example network environment including a speculative planning system in accordance with one or more embodiments.

FIGS. 2A-2D illustrate the speculative planning system implementing a speculative planning process in connection with a LLM approximation agent and a LLM target agent in accordance with one or more embodiments.

FIGS. 3A and 3B illustrate the speculative planning system incorporating a “human-in-the-loop” mechanism to further increase the speed and accuracy of the speculative planning process in accordance with one or more embodiments.

FIG. 4 illustrates a block diagram of the speculative planning system in accordance with one or more embodiments.

FIG. 5 illustrates an example series of acts for generating speculative planning outputs to complete a task in accordance with one or more embodiments.

FIG. 6 illustrates certain components that may be included within a computer system.

### DETAILED DESCRIPTION

The present disclosure relates to systems, methods, and computer-readable media for interactive speculative planning utilizing computational agents to generate action steps for completing a task using one or more generative AI models. As discussed above, LLMs and other generative AI models have demonstrated strong reasoning abilities, enabling them to plan and interact with external tools and the real world. This has led to the development of model agents (e.g., LLM-based agents), which are often used as task solvers and human assistants. The high-performance of these agents, however, often results in reduced computational efficiencies. For example, LLM-based agents often give rise to extended wait times and increased token generation costs as they perform the steps needed to complete requested tasks. Moreover, many LLM-based agents assume that once a user inputs a query (e.g., “Split my dinner bill between my two friends and me”), the LLM-based agent will take over and complete the task. Despite this assumption, a “human-in-the-loop” design where the user plays a central role in how the LLM-based agent completes a requested task leads to faster and more efficient results.

As such, the present disclosure describes a speculative planning system that increases the efficiencies of existing LLM-based agent approaches while also providing human-in-the-loop interaction. In one or more embodiments, and as will be discussed in greater detail below, the speculative planning system leverages two agent systems: an efficient but less capable approximation agent, and a slower but more powerful target agent. For each task, the approximation agent generates action steps sequentially. Simultaneously, for every step the approximation agent produces, the speculative planning system calls the target agent asynchronously to generate the next step, using the current trajectory from the approximation agent as a provisional prefix. In this process, the speculative planning system calls the approximation agent sequentially, while calling the target agent asynchronously. For each action step, if the outputs of the approximation agent and the target agent match, the speculative planning system continues the process. However, if there is a mismatch, the speculative planning system halts the approximation agent, and replaces its output with the target agent's output to ensure performance is not compromised.

Additionally, in one or more embodiments, the speculative planning system generates a graphical user interface where outputs of the approximation agent and the target agent are displayed, and intermediate user inputs may be received. For example, the speculative planning system displays the relevant outputs of the approximation agent and the target agent so that the user can see the steps the agents plan to take in performing a task. At any point, the speculative planning system allows the user to input agreements, disagreements, additional instructions, etc. via the graphical user interface. In one or more embodiments, the speculative planning system utilizes these user inputs as prefixes for the approximation agent and/or target agent as they continue to plan steps for performing the task.

As mentioned above, the speculative planning system improves the efficiency of other LLM-agent systems. For example, the speculative planning system can complete a task with the accuracy of the target agent but with the speed of the approximation agent. If there is disagreement between the steps planned by the approximation agent and the target agent, the runtime of the system will be no worse than if the target agent were working alone. Additionally, by introducing the human-in-the-loop mechanism into the performance of the approximation agent and target agent, the speculative planning system further increases the speed and accuracy of how the approximation agent and the target agent plan steps and perform actions within a task.

In one or more implementations, the methods and steps performed by the speculative planning system reference multiple terms. For example, the term “generative artificial intelligence model” (or “generative AI model”) refers to a computational system that utilizes deep learning and a large number of parameters (e.g., billions or trillions for a large version and fewer for a small version) and trained on one or more extensive datasets to produce coherent, contextually relevant, and fluent outputs (e.g., text and/or images) specific to a particular topic. In many cases, a generative AI model is an advanced computational system that uses natural language processing, machine learning, and/or image processing to generate human-like responses that are coherent and contextually relevant. For instance, generative AI models can create outputs in various formats, including one-word answers, long narratives, images, videos, labeled datasets, documents, tables, and presentations.

Moreover, generative AI models are primarily based on transformer architectures for understanding, generating, and manipulating human language. Generative AI models can also utilize other types of architectures such as recurrent neural network (RNN) architecture, long short-term memory (LSTM) model architecture, convolutional neural network (CNN) architecture, or other types of architectures. Examples of generative AI models include generative pre-trained transformer (GPT) models like GPT-3.5, GPT-4, and GPT-40, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks.

In some instances, a generative AI model includes a large language model (LLM), a small language model (SLM), a large action model (LAM), and a small action model (SAM), which serve as text-based versions of a generative AI model, such as those that receive text prompts and/or generate text outputs. In various implementations, a generative AI model is a multimodal generative model that receives multiple input formats (e.g., text, images, video, data structures) and/or generates multiple output formats.

In one or more embodiments described herein, features of a speculative planning system are discussed in connection with one or more LLMs, referring to a computational model that is designed to understand and generate human language. As such, the LLMs discussed herein are designed and trained to receive task requests and generate and execute steps or planning outputs. Thus, a task may be a text-based input that asks the system to do something-such as when a person asks an assistant to do something. In additional implementations, a task may be received as a voice input, a haptic input, or other type of input. Additionally, as used herein, a “prefix” or “action trajectory” refers to a step or planning output that is used in generating a next step or planning output. It will be appreciated that while one or more embodiments described herein refer specifically to LLMs and LLM agents, embodiments described in connection with LLMs and LLM-based agents may similarly apply to other models and model-based agents associated with different types of generative AI models.

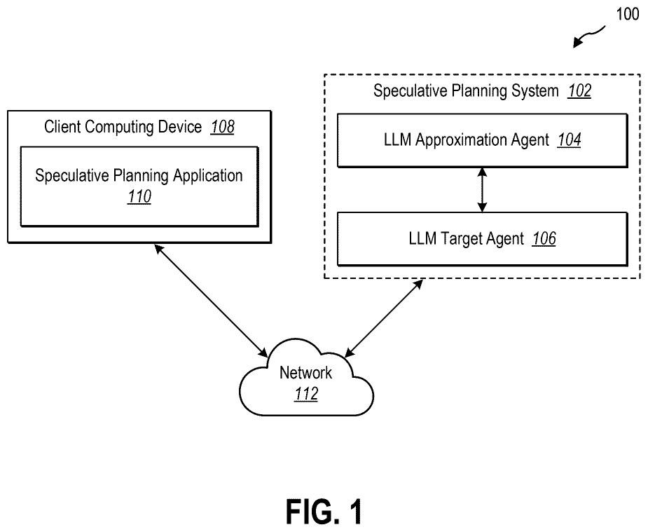

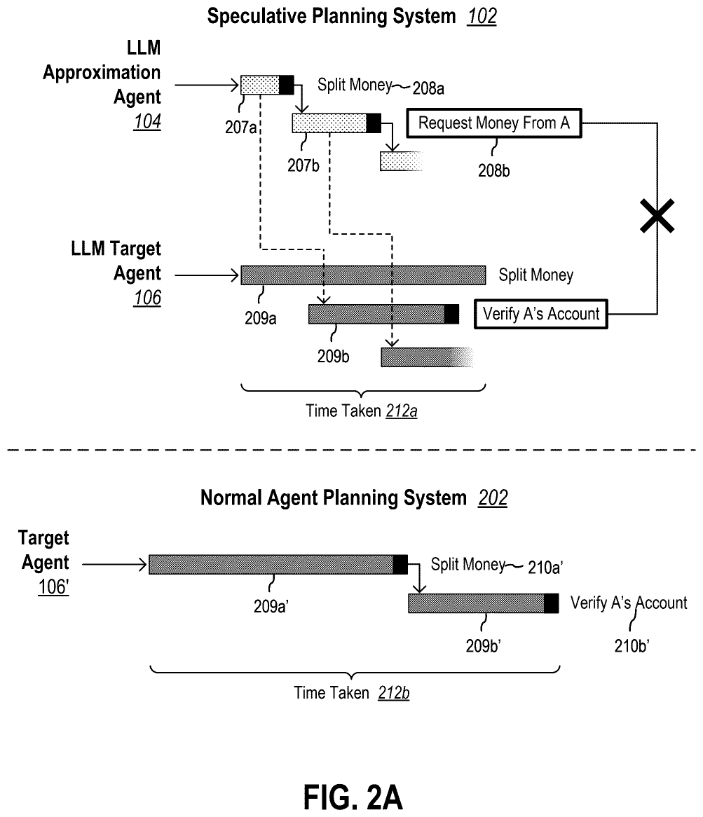

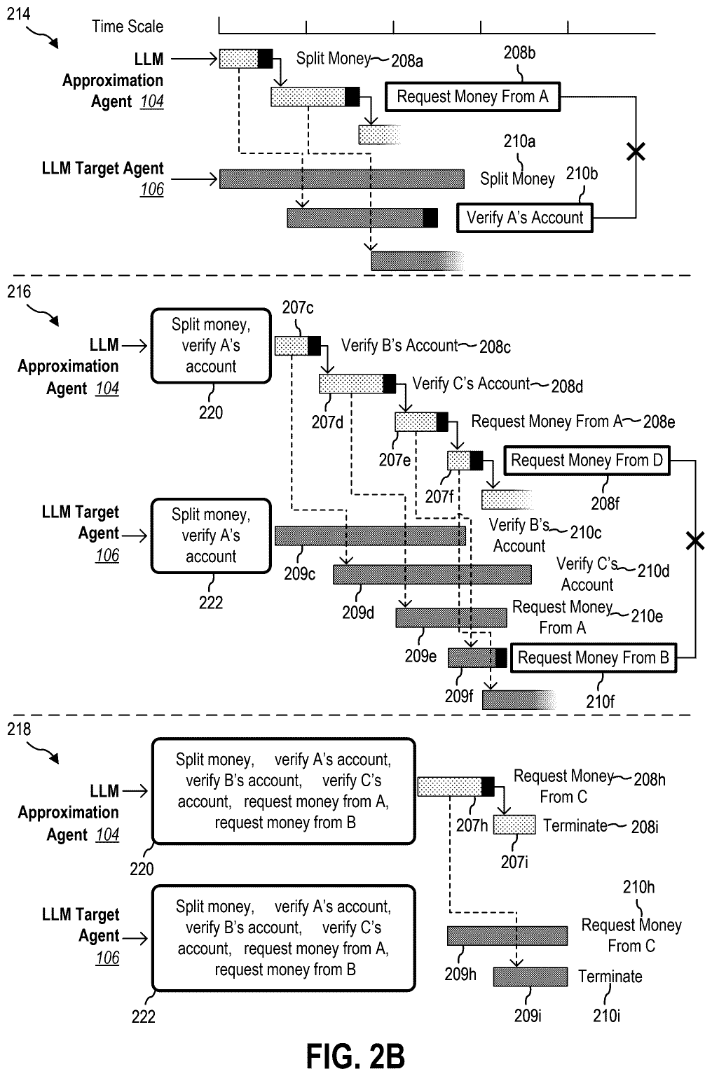

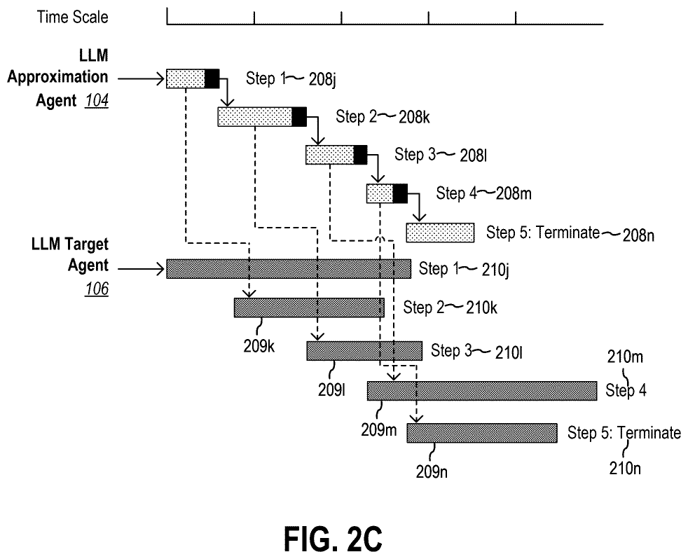

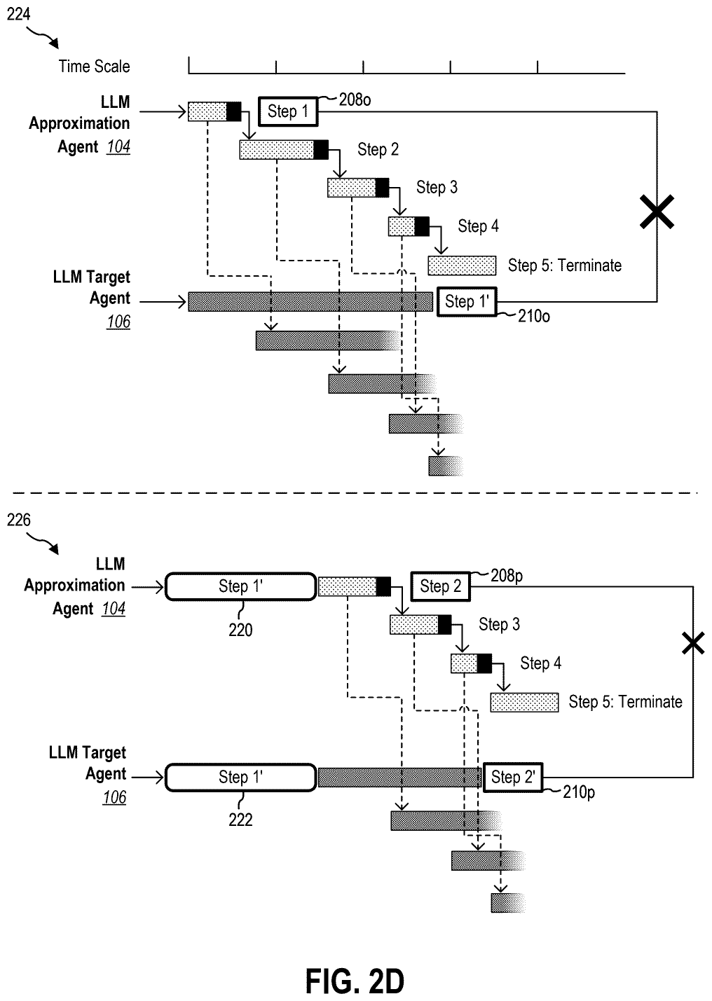

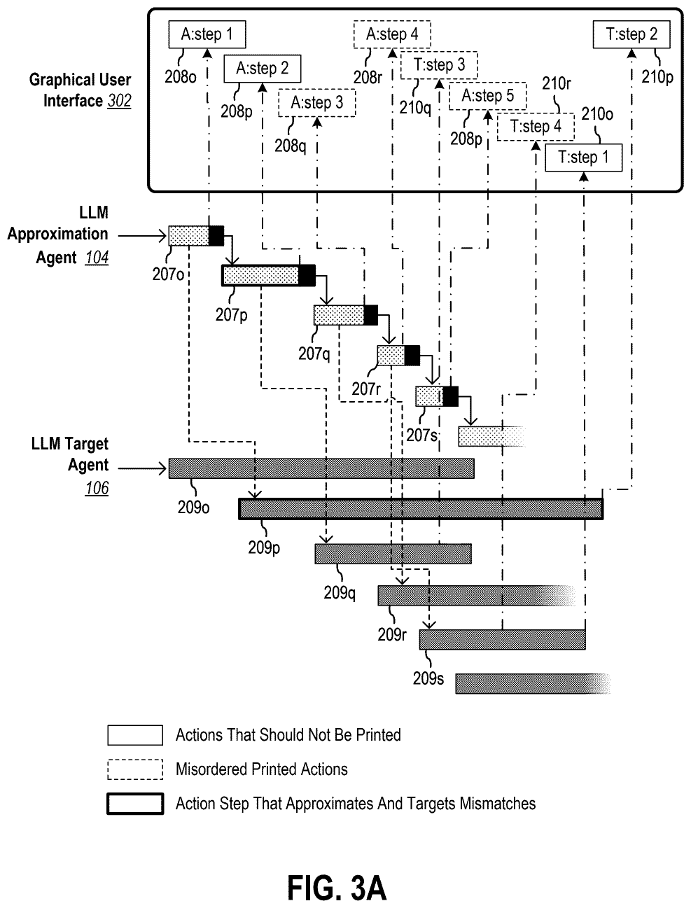

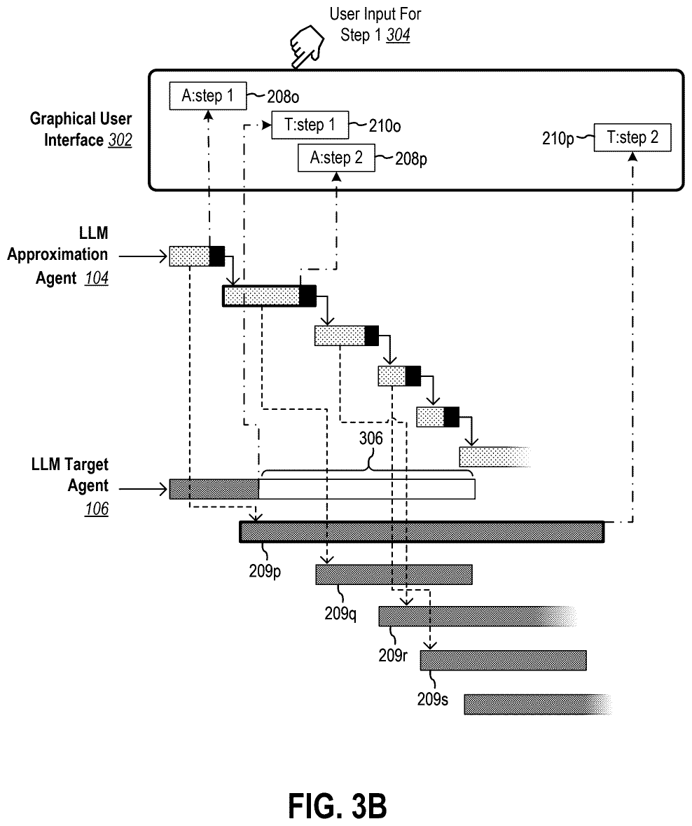

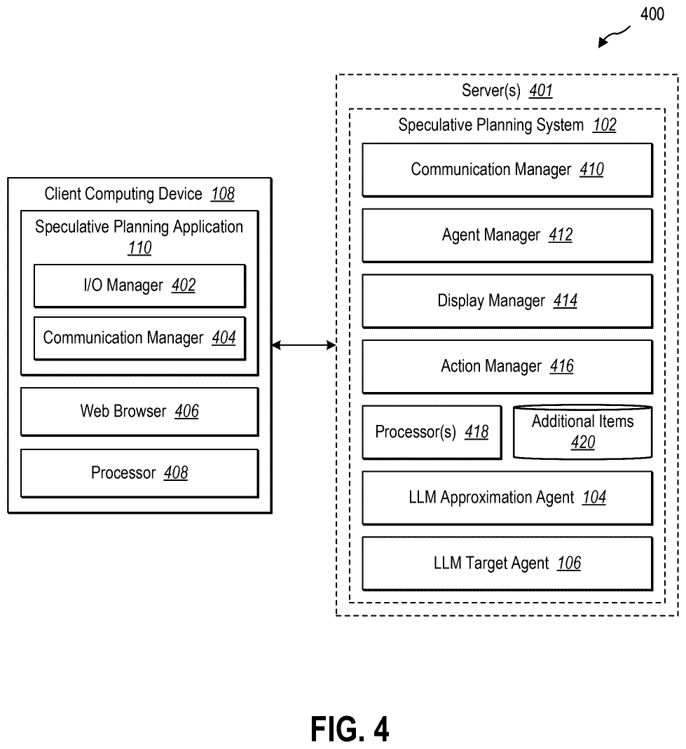

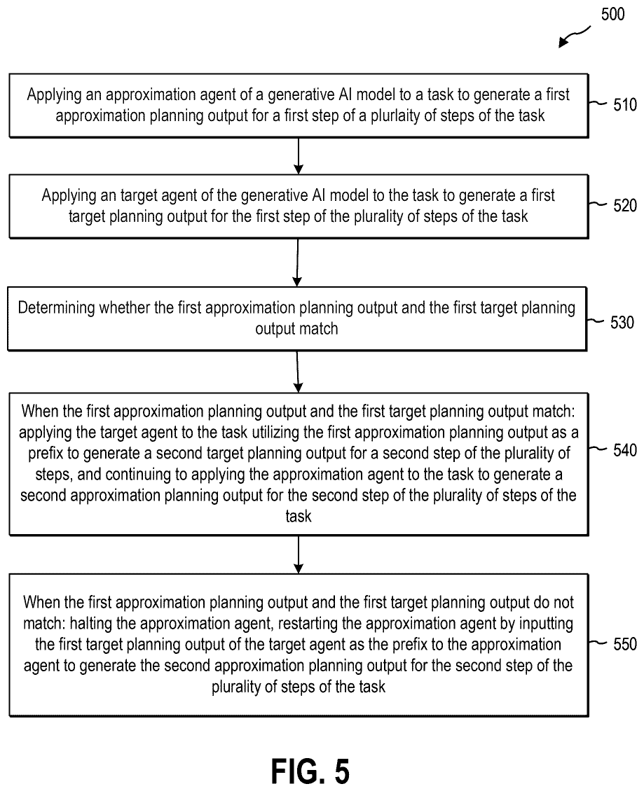

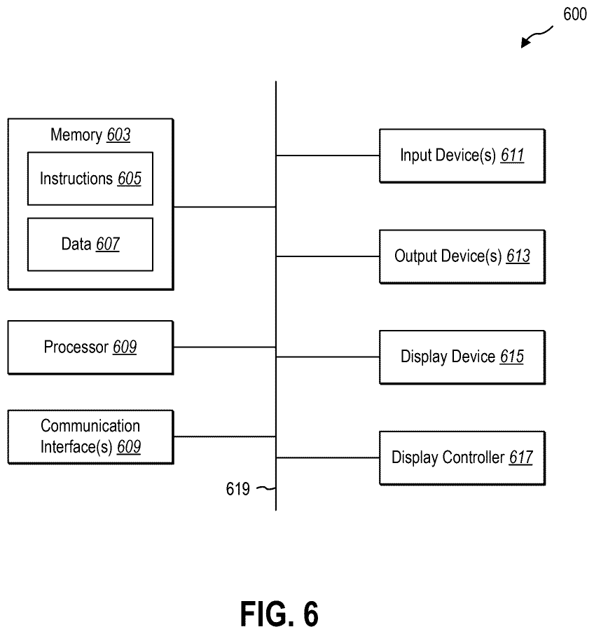

Additional details regarding example implementations of the speculative planning system will be now be discussed in connection with the following figures. To illustrate, FIG. 1 provides an example overview of an environment where the speculative planning system operates in connection with an approximation agent, a target agent, and a client computing device. FIGS. 2A-3B illustrate process diagrams of the speculative planning system engaging the approximation agent and the target agent in response to receiving a task request from a user. FIG. 4 illustrates a schematic diagram of the features and functionality of the speculative planning system. FIG. 5 illustrates a series of acts for generating speculative planning outputs to complete a task. Finally, FIG. 6 illustrates an overview diagram of a computing system.

As just mentioned, FIG. 1 illustrates an example overview of an environment 100 including a speculative planning system 102 operating in connection with a client computing device 108. While FIG. 1 shows example arrangements and configurations with response to various systems including the speculative planning system 102, other arrangements and configurations are possible.

As shown in FIG. 1, the speculative planning system 102 includes an LLM approximation agent 104 and a LLM target agent 106. In one or more embodiments, the LLM approximation agent 104 is a singly-threaded process that generates action steps or planning outputs sequentially. In some embodiments, the LLM approximation agent 104 is efficient and fast but computationally less-capable than the LLM target agent 106. Moreover, in some embodiments, the LLM approximation agent 104 may be a machine learning model, an algorithm, or similar. Indeed, as mentioned above, the LLM approximation agent may refer to a machine learning model, algorithm, or agent that is used in connection with a generative AI model, such as an LLM or other type of model(s).

In one or more embodiments, the LLM target agent 106 is a multi-threaded process that asynchronously generates planning outputs in parallel. As such, the planning outputs of the LLM target agent 106 may not be sequential. In some embodiments, the LLM target agent 106 features slower execution than the LLM approximation agent 104 but generally produces more accurate outputs. Accordingly, in at least one embodiment, the accuracy of the LLM target agent 106 balances the speed of the LLM approximation agent 104.

In one or more embodiments, the LLM approximation agent 104 and the LLM target agent 106 may be co-located within the same server or group of server nodes. In additional or alternative embodiments, the LLM approximation agent 104 and the LLM target agent 106 may be separately located. Regardless of how the LLM approximation agent 104 and the LLM target agent 106 are located, the speculative planning system 102 can provide inputs to and receive outputs from both the LLM approximation agent 104 and the LLM target agent 106. Moreover, the speculative planning system 102 can start operation of the LLM approximation agent 104 and the LLM target agent 106, halt operation of the LLM approximation agent 104 and the LLM target agent 106, and restart operation of the LLM approximation agent 104 and the LLM target agent 106.

As further shown in FIG. 1, the environment 100 can include a client computing device client computing device 108. In one or more embodiments, the client computing device 108 is any computing device that can communicate with the speculative planning system 102. For example, the client computing device 108 may include a personal mobile device (e.g., a smartphone or smart wearable), a laptop computing device, a tablet computing device, or so forth.

As further shown in FIG. 1, the client computing device 108 can include a speculative planning application 110. In one or more embodiments, the speculative planning application 110 displays graphical user interfaces generated by the speculative planning system 102 on the client computing device 108, detects user inputs via those graphical user interfaces, communicates detected inputs to the speculative planning system 102, and updates the graphical user interface based on communications received from the speculative planning system 102.

In more detail, the speculative planning application 110 can include a native application installed on the client computing device 108. Additionally or alternatively, the speculative planning application 110 can include a web browser plugin that operates as part of a web browser installed on the client computing device 108. In at least one embodiment, the speculative planning application 110 operates as a website hosted by the speculative planning system 102 and accessed by the client computing device 108 via a web browser installed thereon.

As further shown in FIG. 1, the speculative planning system 102 and the client computing device 108 may be communicatively coupled through the network 112. In one or more implementations, the network 112 may represent any type or form of communication network, such as the Internet, and may include one or more physical connections, such as a LAN, and/or wireless connections, such as a WAN.

Although FIG. 1 illustrates components of the environment 100 in one arrangement, other arrangements are possible. For example, in one implementation, the LLM approximation agent 104 may operate as a standalone application on the client computing device 108. Additionally, in some implementations, the LLM approximation agent 104 and/or the client computing device 108 may be publicly accessible by additional parties in addition to the speculative planning system 102.

As mentioned above, FIGS. 2A-2D illustrate an example of the speculative planning system 102 utilizing the LLM approximation agent 104 and the LLM target agent 106 to efficiently determine the action steps that should be taken to complete a task. FIGS. 3A and 3B illustrate how the speculative planning system 102 incorporates a “human-in-the-loop” mechanism to further increase the efficiency and accuracy of the LLM approximation agent 104 and the LLM target agent 106.

Generally, the speculative planning system 102 seeks to expedite agent planning by employing a fast and efficient approximation agent (e.g., the LLM approximation agent 104) to resolve the task sequentially, with each approximation planning output (e.g., step) representing an action to be executed. For every length-i prefix of the approximation planning output generated by the LLM approximation agent 104, both the LLM approximation agent 104 and the LLM target agent 106 are asynchronously run to generate the i+1th output (e.g., the next step). If the speculative planning system 102 determines that the i+1th output generated by both agents matches, it indicates that the more efficient agent (e.g., the LLM approximation agent 104) can complete the step. The speculative planning system 102 proceeds to use the length i+1 planning output as a prefix to generate the i+2th planning output. If the speculative planning system 102 determines that the i+1th planning output generated by both agents does not match, the speculative planning system 102 further determines that the LLM approximation agent 104 has erred at the i+1th planning output (e.g., the last step) and replaces that planning output of the LLM approximation agent 104 with the result of the LLM target agent 106. Additionally, the speculative planning system 102 halts all concurrent calls or process threads of the LLM approximation agent 104 and the LLM target agent 106 with prefixes longer than i+1, as those calls or process threads are based on an incorrect prefix and their results are unusable.

In more detail, FIG. 2A illustrates a comparative overview of how the speculative planning system 102 utilizes the LLM approximation agent 104 and the LLM target agent 106 to determine planning outputs (e.g., action steps) of a task versus how a typical agent determines the same steps as part of the same task. For example, the speculative planning system 102 achieves time savings by having the LLM target agent 106 utilize the result generated by the faster LLM approximation agent 104 as a prefix to generate the next step, rather than waiting for prefix steps from the slower LLM target agent 106 to be completed.

In the example shown in FIG. 2A, both the speculative planning system 102 and conventional agent planning system 202 generate the first steps of the same task. The conventional agent planning system 202 generates the target planning output 210a′ (e.g., “split money”) and the target planning output 210b′ (e.g., “verify A's account”) by applying a LLM target agent 106′ sequentially to the process threads 209a′ and 209b′, respectively. The LLM target agent 106′ utilizes the target planning output 210a′ that results from the process thread 209a′ as a prefix for the generating the target planning output 210b′. As such, the time 212b taken by the conventional agent planning system 202 to generate the target planning output 210a′ and the target planning output 210b′ is simply the sum of the time it takes the LLM target agent 106′ to complete the process thread 209a′ followed by the process thread 209b′.

In contrast, as illustrated in FIG. 2A, the speculative planning system 102 can generate the same action steps (e.g., “split money” and “verify A's account”) in a shorter time 212a. For example, when initiating speculative planning, the current action trajectory prefix is empty. As such, the speculative planning system 102 simultaneously starts the LLM approximation agent 104 on the process thread 207a to generate the approximation planning output 208a (e.g., “split money) and the LLM target agent 106 on the process thread 209a to generate the target planning output 210a (e.g., “split money”). Upon the LLM approximation agent 104 completing the process thread 207a to generate the approximation planning output 208a, the speculative planning system 102 simultaneously applies both the LLM approximation agent 104 to the process thread 207b to generate the approximation planning output 208b (e.g., “request money from A) and the LLM target agent 106 to the process thread 209b to generate the target planning output 210b (e.g., “verify A's account”). It is important to note that the speculative planning system 102 utilizes the approximation planning output 208a (e.g., “split money”) as the current action trajectory (e.g., the prefix) when starting the LLM target agent 106 on the process thread 209b. The speculative planning system 102 repeats this process for subsequent steps.

Once the LLM target agent 106 completes the process thread 209a to generate the target planning output 210a (e.g., “split money”), the speculative planning system 102 confirms the accuracy of the approximation planning output 208a (e.g., “split money”) generated by the LLM approximation agent 104 by determining that both the target planning output 210a and the approximation planning output 208a match. In light of this, the approximation planning output 208b (e.g., “request money from A”) generated by the LLM approximation agent 104 based on the approximation planning output 208a is potentially correct, while the target planning output 210b (e.g., “verify A's account”) generated by the LLM target agent 106 based on the target planning output 210a is definitively correct. However, if the LLM target agent 106 completes its process thread 209b to generate the target planning output 210b (e.g., “verify A's account”) before completing the process thread 209a to generate the target planning output 210a (e.g., “split money”), and the approximation planning output 208b (e.g., “request money from A”) generated by the LLM approximation agent 104 is incorrect, the speculative planning system 102 can deem all subsequent outputs based on action trajectory of the approximation planning output 208a and the approximation planning output 208b unusable.

As such, the speculative planning system 102 can determine that the approximation planning output 208b generated by the LLM approximation agent 104 does not match the target planning output 210b generated by the LLM target agent 106. In response to this determination, the speculative planning system 102 can halt the LLM approximation agent 104, and restart the LLM approximation agent 104 utilizing the target planning output 210b generated by the LLM target agent 106 as a prefix for the next process thread started by the LLM approximation agent 104. At this point, as shown in FIG. 2A, the total time 212a taken by the speculative planning system 102 to generate the approximation planning output 208a and the target planning output 210b is less than the time 212b taken by the conventional agent planning system 202 to generate the same steps. This is because the speculative planning system 102 utilizes the approximation planning output 208a that is quickly generated by the LLM approximation agent 104 as a prefix for the LLM target agent 106 to generate the ultimately correct target planning output 210b.

FIG. 2B illustrates the speculative planning system 102 utilizing the LLM approximation agent 104 and the LLM target agent 106 to generate planning outputs over multiple iterations (e.g., the iterations 214, 216, and 218). For example, the actions of the speculative planning system 102 in the iteration 214 are described above in connection with FIG. 2A. During the iteration 214, the speculative planning system 102 initiates the LLM approximation agent 104 and the LLM target agent 106 on the same task (e.g., “split the bill between three people”). As discussed above, the LLM approximation agent 104 generates the approximation planning outputs 208a and 208b, while the LLM target agent 106 generates the target planning outputs 210a and 210b.

As the LLM approximation agent 104 and the LLM target agent 106 generate corresponding planning outputs (e.g., outputs generated in response to corresponding process threads), the speculative planning system 102 determines whether these corresponding planning outputs match. For example, the speculative planning system 102 can compare the approximation planning output 208b to the target planning output 210b to determine that these planning outputs do not match. In one or more embodiments, the speculative planning system 102 can determine that planning outputs match when there is a string match or token match between the planning outputs. Additionally or alternatively, the speculative planning system 102 can determine that planning outputs match when a threshold number of tokens, characters, or strings match between the planning outputs. Additionally or alternatively, the speculative planning system 102 can leverage machine learning or another type of analysis to determine that the planning outputs are directed to the same keyword, category, idea, or so forth. As shown in FIG. 2B in the iteration 214, the speculative planning system 102 can determine that the approximation planning output 208b and the target planning output 210b do not match because there is no string match between them.

In response to this determination, the speculative planning system 102 can halt operation of the LLM approximation agent 104 and restart the LLM approximation agent 104 utilizing the target planning output 210b as the prefix (e.g., the action trajectory) for the LLM approximation agent 104 to continue operation. For example, as shown in the iteration 216, the speculative planning system 102 adds the target planning output 210b (e.g., “verify A's account”) to the approximation agent action trajectory 220 and to the target agent action trajectory 222 and continues operation of the LLM approximation agent 104 and the LLM target agent 106 based on their respective action trajectories. As such, the LLM approximation agent 104 continues processing the process thread 207c, followed by the process thread 207d and the process thread 207e. As indicated by the dotted arrows, the speculative planning system 102 can utilize the approximation planning output 208c as the prefix for the process thread 209d initiated by the LLM target agent 106.

As discussed above, the speculative planning system 102 continues to determine whether approximation planning outputs and target planning outputs correspond. For example, for each new target planning output generated by the LLM target agent 106, the speculative planning system 102 can identify the corresponding approximation planning output and determine whether that approximation planning output matches the target planning output. To illustrate, the speculative planning system 102 can determine that the approximation planning output 208c and the target planning output 210c match, that the approximation planning output 208d and the target planning output 210d match, and that the approximation planning output 208e and the target planning output 210e match. The speculative planning system 102 can next compare the approximation planning output 208f and the target planning output 210f to determine that there is no match between the approximation planning output 208f and the target planning output 210f.

As such, the speculative planning system 102 halts operation of the LLM approximation agent 104 and—in the next iteration 218—adds the target planning output 210f (e.g., “request Monday from B) to the approximation agent action trajectory 220. The speculative planning system 102 then restarts the LLM approximation agent 104 based on the updated approximation agent action trajectory 220 including the target planning output 210f.

In one or more embodiments, the speculative planning system 102 introduces a hyperparameter (k) to prevent an excessive number of concurrent LLM target agent 106 process threads. The hyperparameter represents a predetermined number (e.g., a maximum number) of approximation planning outputs that can be generated and/or executed before all corresponding LLM target agent 106 process threads are completed. By controlling the value of the hyperparameter (k), the speculative planning system 102 ensures that users can flexibly manage the number of concurrent LLM target agent 106 process threads according to preferences and computational resources. As such, in one or more embodiments, the speculative planning system 102 allows the hyperparameter (k) to be user-configurable.

Returning to FIG. 2B, the speculative planning system 102 continues operation of the LLM approximation agent 104 and the LLM target agent 106 over the process threads 207h and 207i, and the process threads 209h and 209i, respectively. As discussed above, the speculative planning system 102 continues to determine whether the approximation planning outputs 208h and 208i match the target planning outputs 210h and 210i. Finally, in response to determining that the approximation planning output 208i and the target planning output 210i both indicate that the next step is “terminate,” the speculative planning system 102 can cease operation of the LLM approximation agent 104 and the LLM target agent 106.

FIGS. 2C and 2D further illustrate the efficiencies of the speculative planning system 102. For example, FIG. 2C illustrates a best-case scenario where the speculative planning system 102 determines that the approximation planning outputs 208j, 208k, 208l, 208m, and 208n correspond to the target planning outputs 210j, 210k, 2101, 210m, and 210n, respectively. Because the planning outputs correspond at every step, the speculative planning system 102 can utilize the approximation planning outputs 208j, 208k, 208l, and 208m as prefixes to each of the LLM target agent 106 process threads 209k, 2091, 209m, and 209n—as indicated by the dotted arrows.

Thus, the speculative planning system 102 effectively uses the speed of the LLM approximation agent 104 to decrease the processing time of the LLM target agent 106. In the worst-case scenario (i.e., where there is no correspondence between the approximation planning outputs and the target planning outputs), the efficiency of the speculative planning system 102 would be no worse than if the LLM target agent 106 was operating alone.

To further illustrate the latency improvement demonstrated by the speculative planning system 102, the following variables are defined:
n: the number of planning steps (e.g., planning outputs) for a task
time(A, s): the time the approximation agent A (e.g., the LLM approximation agent 104) takes to generate step s (e.g., an approximation planning output) in the plan
time(T, s): the time the target agent T (e.g., the LLM target agent 106) takes to generate step s (e.g., a target planning output) in the plan
e(s): the time to execute a step s (e.g., a planning output) in the plan and return an observation
   When no speculative planning is utilized to generate and execute the whole plan, the total time for the plan can be expressed as:

$${\sum }_{i \leq n} ( time ( T , {s}_{i} ) + e ( {s}_{i} ) )$$

The set of breaking steps B, which consists of steps s in the plan where the sequential generation of the LLM approximation agent 104 must be halted, is first defined when employing speculative planning. These steps may include instances where the prediction of the LLM approximation agent 104 (aᵢ=A(i)) differs from the prediction of the LLM target agent 106 (tᵢ=T(i)) for the i-th step in the planning, as well as when the approximation process reaches the hyperparameter k.

The time taken to generate and execute the entire plan is then determined by the following equation, which is dominated by the case where a particular step i (e.g., a target planning output) takes the target agent T (e.g., the LLM target agent 106) a very long time to generate:

$${\sum }_{{B}_{i} ∈ B [ : - 1 ]} ( max \{ ( {\sum }_{x ∈ {B}_{i , ... , j}} ( time ( A , {s}_{x} ) + e ( {s}_{x} ) ) + time ( T , {s}_{j} ) ) \vert {B}_{j} \leq j \leq {B}_{i + 1} \} )$$

In the best-case scenario, as discussed above, with reference to FIG. 2C, no step generated by A differs from the step generated by T. Thus, in that specific case, the expression of B is all numbers smaller than n mod k:

$$B = \{ i ∈ ℕ \vert 0 \leq i \leq n , i mod k = 0 \}$$

In a special case if all calls of Tᵢ end before calls of Tᵢ₊₁:

$${\sum }_{i \leq n - 1} ( time ( A , {s}_{i} ) + e ( {s}_{i} ) ) + max ( time ( A , {s}_{n} ) + e ( {s}_{n} ) , time ( T , {s}_{n} ) )$$

As mentioned above, the worst-case scenario is that all steps generate by the A are rejected by T. In this extreme case, the set of breaking steps, B includes all integers from 0 to n−1:

$$B = [ 0 , n ]$$

Under these circumstances, the time taken to generate and execute the plan degrades to the situation where speculative planning is not utilized. This equation calculates the sum of the time taken to generate and execute each step in the plan sequentially, without any speculative planning. The total time can be expressed as:

$${\sum }_{i \leq n} time ( T , {s}_{i} ) + e ( {s}_{i} ) )$$

To illustrate, FIG. 2D shows the speculative planning system 102 determining that the approximation planning output 208o does not correspond or match with the target planning output 210o in an iteration 224. In response to this determination, the speculative planning system 102 halts the LLM approximation agent 104 and discards any approximation planning outputs that were generated after the approximation planning output 208o (e.g., “step 2,” “step 3,” “step 4,” “step 5: terminate”). The speculative planning system 102 then restarts the LLM approximation agent 104 with the target planning output 210o (e.g., “step 1′”). As shown in the iteration 226, the speculative planning system 102 adds the target planning output 210o to the approximation agent action trajectory 220 and the target agent action trajectory 222.

At the iteration 226, the speculative planning system 102 again determines that the approximation planning output 208p does not correspond or match with the target planning output 210p. In response to this determination, the speculative planning system 102 performs the same actions described above. The speculative planning system 102 continues to determine—in this worst-case scenario—that each approximation planning output does not match the corresponding target planning output 210. This worst-case scenario demonstrates that, in terms of time efficiency, speculative planning is upper-bounded by the time taken in non-speculative planning. This implies that the maximum time required for speculative planning will not exceed the time taken by the traditional, non-speculative approach.

While generating planning outputs to complete a task, the speculative planning system 102 generates a number of tokens. To analyze the total number of tokens generated by the speculative planning system 102, the following variables are defined:
token(A, s): the token of the approximation agent A (the LLM approximation agent 104) requires to generate step s (e.g., an approximation planning output) in the plan
token(T, s): the token of the approximation agent t (the LLM target agent 106) requires to generate step s (e.g., a target planning output) in the plan

$$start\_time ( A , {s}_{i} ) = {\sum }_{j = b}^{j = i - 1} ( time ( A , {s}_{j} ) + e ( {s}_{j} ) ) :$$

the start time of A to generate step sᵢ since the one previous breaking point b

$$start\_time ( T , {s}_{i} ) = {\sum }_{j = b}^{j = i - 1} ( time ( T , {s}_{j} ) + e ( {s}_{j} ) ) :$$

the start time of T to generate step sᵢ since the one previous breaking point b

$$end\_time ( A , {s}_{i} ) = {\sum }_{j = b}^{j = i} ( time ( A , {s}_{j} ) + e ( {s}_{j} ) ) :$$

the end time of A to generate step sᵢ since the one previous breaking point b

$$end\_time ( T , {s}_{i} ) = {\sum }_{j = b}^{j = i - 1} ( time ( A , {s}_{j} ) + e ( {s}_{j} ) + time ( T , {s}_{i} ) :$$

the end time of T to generate step sᵢ since the one previous breaking point b
   When not utilizing speculative planning, the total number of tokens used to generate and execute the plan is:

$${\sum }_{i \leq n} token ( T , {s}_{i} )$$

The speculative planning system 102 generally utilizes more tokens, as both the LLM target agent 106 and the LLM approximation agent 104 go through the entire plan, potentially generating tokens and planning outputs that are not used in the final plan. Between any two breaking points Bᵢ and Bᵢ₊₁, the number of tokens generated by the speculative planning system 102 is the sum of tokens generated by A (e.g., the LLM approximation agent 104) and T (e.g., the LLM target agent 106) for steps sⱼ such that Bᵢ≤j≤Bᵢ₊₁ as well as tokens that are generated but not used by both A and T for any step sⱼ such that j≤Bᵢ₊₁, where the process ends before T finishes the process for the step Bᵢ₊₁. Thus, the tokens generated T_{B}_{ₜ} between two consecutive breaking points Bᵢ and Bᵢ₊₁ is:

$${T}_{{B}_{t}} = {\sum }_{j = {B}_{i} + 1}^{j = {B}_{i + 1}} token ( A , {s}_{j} ) + token ( T , {s}_{j} ) ) + {\sum }_{j = {B}_{i + 1} + 1}^{{M}_{i}} ( token ( A , {s}_{j} ) + token ( T , {s}_{j} ) )$$

Where

$${\sum }_{j = {B}_{i} + 1}^{j = {B}_{i + 1}} token ( A , {s}_{j} ) + token ( T , {s}_{j} )$$

is the sum of tokens generated by A and T between Bᵢ and Bᵢ₊₁
Where

$${\sum }_{j = {B}_{i + 1} + 1}^{j = {M}_{i}} token ( A , {s}_{j} ) + token ( T , {s}_{j} ) )$$

are the unused tokens
Where Q=max_{B}_{ᵢ}_{<l≤B}_{ᵢ₊₁} {end_time(T, sₜ)} is the ending time for all steps between Bᵢ and Bᵢ₊₁ to be computed
Where Mᵢ=min{max{l<n|end_time(A, sₗ)≤Q}, k+Bᵢ}−Bᵢ₊₁ is the number of unused steps initiated by A, that is all processes that end before Q but are computed based on an incorrect prefix
   Thus, the ultimate total number of tokens generated with be the summation of T_{B}_{ₜ}ₛ:

$$T = {\sum }_{{B}_{t} ∈ B [ : - 1 ]} {T}_{{B}_{i}}$$

In the best-case scenario, all planning outputs or steps generated by A matches those generated by T. As such, all tokens generated are used, as shown by:

$${\sum }_{i \leq n} ( token ( A , {s}_{i} ) + token ( T , {s}_{i} ) )$$

In the worst-case scenario, none of the planning outputs or steps generated by A matches those generated by T. Additionally, each T process finishes after all A processes are completed, and the earliest called T process always finishes last. Without loss of generality, for the planning outputs or steps between B₀ and B₁, the condition can be expressed as:

$$∀ {B}_{0} \leq i \leq {B}_{1} , end\_time ( T , {s}_{i} ) \geq end\_time ( A , {s}_{{B}_{1}} )$$

$$and$$

$$∀ {B}_{0} \leq i \leq {B}_{1} , ∀ i \leq l \leq {B}_{1} , end\_time ( T , {s}_{i} ) \geq end\_time ( T , {s}_{l} )$$

In such a case, each A process i is run for i times (e.g., the first process runs once, the second process runs twice), and each T process i is run for i times. Consequently, the total number of tokens generated in the worst-case scenario is:

$${\sum }_{i = 1}^{n} i * ( token ( A , {s}_{i} ) + token ( T , {s}_{i} ) )$$

In addition to generating tokens in planning the steps of a task, the speculative planning system 102 also utilizes processing resources. The rate needed by the speculative planning system 102 to run the speculative planning algorithm can be determined by the maximum number of concurrently running agent calls (e.g., process threads). When not utilizing speculative planning, all agent calls are executed sequentially. Consequently, the rate of usage (e.g., the maximum number of concurrently running agent calls) is one.

When using speculative planning, the speculative planning system 102 has at least two concurrent calls: 1 for A and 1 for T. But it can be more than 2, as shown in the Figures described above. For example, the speculative planning system 102 can have many process threads running at the same moment. The maximum concurrent C process threads can be the maximum concurrent CB, between any two consecutive breaking points Bᵢ and Bᵢ₊₁. To this end, the process thread of the LLM target agent 106 covering the most starts of other process threads of the LLM target agent 106 is identified, and 1 is added for the additional process thread of the LLM approximation agent 104:

$${C}_{{B}_{t}} = min \{ {max}_{{B}_{t} \leq j \leq {B}_{t + 1}} \vert \{ l \leq n \vert start\_time ( T , {s}_{j} ) \leq start\_time ( A , {s}_{l} ) \leq end\_time ( T , {s}_{j} ) \} \vert + 1 , k + 1 \}$$

Note the hyperparameter k controls the number of sequential A calls can be conducted without waiting for all corresponding T calls can be finished. Therefore, CB, is upper-bounded by k+1 between any pair of consecutive Bᵢ and Bᵢ₊₁. And thus, the maximum concurrent C process threads is the maximum of all C_{B}_{ₜ}:

$$C = max \{ {C}_{{B}_{t}} \vert {B}_{i} ∈ B [ : - 1 ] \}$$

In the best-case scenario, there are exactly 2 concurrent process threads running (e.g., one A process thread and one T process thread), and there is no time overlap between any two T process threads. This may only occur when for each step sᵢ, time(T, sᵢ)≤time(A, sᵢ). In the worst-case scenario, there is a sequence of steps i to i+k such that ∀i<j≤i+k, end_time(T,i)>start_time(T,j). In this case, there exists a time point when k process threads of the LLM target agent 106 are running concurrently, resulting in a total of k+1 concurrent processes.

As mentioned above, the speculative planning system 102 incorporates a human-in-the-loop mechanism to further increase the accuracy and efficiency of speculative planning utilizing the LLM approximation agent 104 and the LLM target agent 106. For example, in one or more embodiments, the speculative planning system 102 generates and provides a graphical user interface via the speculative planning application 110 on the client computing device 108. The speculative planning system 102 can provide outputs via the graphical user interface indicating planning outputs of the LLM approximation agent 104 and the LLM target agent 106. At any point, the speculative planning system 102 can receive user inputs via the graphical user interface that agree with planning outputs, disagree with planning output, or provide new direction to the LLM approximation agent 104 and the LLM target agent 106. In this way, the speculative planning system 102 can utilize this user input to short-cut the processing time that may accompany the speculative planning process as the LLM approximation agent 104 and the LLM target agent 106 generate planning outputs and try to find agreement between themselves.

Despite the accuracies and efficiencies introduced by this human-in-the-loop mechanism, the graphical user interface generated by speculative planning system 102 can give rise to some confusions. For example, immediately printing planning outputs of both the LLM approximation agent 104 and the LLM target agent 106 to the graphical user interface means 1) some planning outputs of the LLM approximation agent 104 will be printed even though they may be incorrect when there is a disagreement with the LLM target agent 106, and 2) the planning outputs of the LLM target agent 106 will likely not be sequential within the graphical user interface.

To illustrate, FIG. 3A give a sequential overview of the LLM approximation agent 104 running the process threads 207o, 207p, 207q, 207r, and 207s, while the LLM target agent 106 runs the process threads 209o, 209p, 209q, 209r, and 209s. As each process thread finishes, the speculative planning system 102 immediately prints the corresponding planning output within a graphical user interface 302.

As shown, this immediate printing of planning outputs gives rise to a series of inaccuracies. For example, LLM approximation agent 104 is singly-threaded and works through the process threads 207o-207s sequentially. It follows that the approximation planning outputs 208o, 208p, 208q, 208r, and 208s print sequentially within the graphical user interface 302 relative to each other. The LLM target agent 106, however, is multi-threaded and begins running the process threads 209o-209s asynchronously. As such, the target planning outputs 210o, 210p, 210q, and 210r print out-of-order within the graphical user interface 302 because the corresponding process threads 209o-209r finish out-of-order.

Moreover, as further shown in FIG. 3A, the speculative planning system 102 may find disagreement between planning outputs at any point. In response to such a disagreement, as discussed above, the speculative planning system 102 halts the LLM approximation agent 104 and discards any approximation planning outputs that have resulted from subsequent process threads. The speculative planning system 102 also halts any target process threads that may have started using the incorrect approximation planning output as a prefix.

When all planning outputs are immediately printed to the graphical user interface 302, however, such a disagreement between planning outputs results in irrelevant information being presented to the user. For example, as shown in FIG. 3A, the speculative planning system 102 determines that the approximation planning output 208p resulting from the process thread 207p and the target planning output 210p resulting from the process thread 209p do not match. The speculative planning system 102 then halts the LLM approximation agent 104, discards the process threads 207q-207s and the corresponding approximation planning outputs 208q-208s, and restarts the LLM approximation agent 104 using the target planning output 210p as a prefix. The speculative planning system 102 also discards the process threads 209q-209s and the corresponding target planning outputs 210q-210r that were initiated and generated based on the incorrect approximation planning output 208p.

Despite this, the incorrect approximation planning outputs 208q-208s and target planning outputs 210q-210r have already printed to the graphical user interface 302 by the time the speculative planning system 102 determines that the approximation planning output 208p and the target planning output 210p do not match. As such, the graphical user interface 302 is full of information that is irrelevant and not part of the final plan.

To ensure that the graphical user interface 302 is clear and understandable for tracking the progress of the LLM approximation agent 104 and the LLM target agent 106, the speculative planning system 102 can reschedule how planning outputs are printed to the graphical user interface 302. In one or more embodiments, this rescheduling enables the speculative planning system 102 to print the planning outputs to the graphical user interface 302 in a way that allows the user to sequentially view the planning outputs of the LLM approximation agent 104 and the LLM target agent 106 with minimal perceived latency.

To reschedule printing of planning outputs, the speculative planning system 102 prints an approximation planning output to the graphical user interface 302 only after determining that all preceding approximation planning outputs matches corresponding target planning outputs (i.e., the preceding approximation planning outputs are confirmed). The speculative planning system 102 further prints a target planning output only after any preceding target planning outputs have already been printed-ensuring the target planning outputs are printed sequentially. By rescheduling the print-out of planning outputs in this manner, the speculative planning system 102 not only ensures a sequential presentation but also highlights the time difference between the LLM approximation agent 104 and the LLM target agent 106, allowing the user to identify which action is bottlenecking the running time.

Once the speculative planning system 102 has ensured that planning outputs are printed to the graphical user interface 302 in a clear and understandable way, the speculative planning system 102 further enables user interactions with the graphical user interface 302 to actively interrupt the speculative planning process. For example, two scenarios anticipated by the speculative planning system 102 where users may interact with the speculative planning process may include 1) when noticing excessive perceived latency between the last presented planning output of the LLM approximation agent 104 and the next planning output of the LLM target agent 106 (e.g., assuming the generation speed of the LLM approximation agent 104 is sufficiently fast such that users would not interrupt it), and 2) when dissatisfied with the planning outputs of both the LLM approximation agent 104 and the LLM target agent 106 for a given step.

For the first scenario, the graphical user interface 302 presentation for the i-th step of the plan can indicate the latency lᵢ between the presentation of the approximation planning output Aᵢ and the target planning output Tᵢ, users can choose to interrupt during the time of lᵢ and input their own value. The speculative planning system 102 can detect this interruption and halt the process of Tᵢ, incorporating the detected user input into the action trajectory of the LLM target agent 106, while allowing all other concurrent processes to continue.

To illustrate, FIG. 3B shows the same process thread progression of the LLM approximation agent 104 and the LLM target agent 106 as described above with regard to FIG. 3A. In FIG. 3B, however, the speculative planning system 102 has employed rescheduling to ensure the graphical user interface 302 displays the relevant approximation planning outputs 208o, 208p and the relevant target planning outputs 210o, 210p in the correct order. At some point between displaying the approximation planning output 208o and the target planning output 210p, the speculative planning system 102 may detect a user input 304 via the graphical user interface 302 in response to the approximation planning output 208o. In one or more embodiments, the detected user input 304 may be in response to the user wishing to interrupt the speculative planning process due to excessive latency in waiting for the target planning output 210o.

In response to receiving the user input 304, the speculative planning system 102 can halt the LLM target agent 106, add the user input 304 to the action trajectory (e.g., the target agent action trajectory 222, not shown) for the LLM target agent 106 and restart the target agent LLM target agent 106 based on the new action trajectory. As indicated in FIG. 3B, this user interruption can reduce processing time 306 taken by the LLM target agent 106.

For the second scenario discussed above, the speculative planning system 102 allows users to interrupt the speculative planning process when they find that neither the approximation planning output nor the target planning output is satisfactory for a given step. For example, in one or more embodiments, the speculative planning system 102 allows the user to interrupt and input their own optimal step for step i once the target planning output Tᵢ is printed to the graphical user interface 302. In at least one embodiment, the speculative planning system 102 only allows for this type of interruption for a threshold amount of time starting when the target planning output Tᵢ is printed to the graphical user interface 302 and ending before any additional planning outputs are printed to the graphical user interface 302.

As mentioned above, and as shown in FIG. 4, the speculative planning system 102 controls and manages the LLM approximation agent 104 and the LLM target agent 106 to perform speculative planning in connection with a task. FIG. 4 is a block diagram 400 of the speculative planning system 102 operating within one or more memories of server(s) 401 while performing speculative planning. As such, FIG. 4 provides additional detail with regard to these functions. For example, as shown in FIG. 4, the speculative planning system 102 can include a communication manager 410, an agent manager 412, a display manager 414, and an action manager 416, in addition to the LLM approximation agent 104, the LLM target agent 106, and additional items 420. Additionally, as further shown in FIG. 4, the speculative planning system 102 can interact with the speculative planning application 110 on the client computing device 108. In one or more implementations, the speculative planning application 110 can include an input output (I/O) manager 402 and a client communication manager 404.

In certain implementations, the speculative planning system 102—alone or in connection with the speculative planning application 110—may represent one or more software applications, modules, or programs that, when executed by a computing device, may cause the computing device to perform one or more tasks. For example, and as will be described in greater detail below, one or more of the I/O manager 402 or the client communication manager 404 may represent software stored and configured to run on one or more computing devices, such as the client computing device 108. Similarly, one or more of the communication manager 410, the agent manager 412, the display manager 414, or the action manager 416 may represent software stored and configured to run on one or more computing devices, such as the server(s) 401. Any of the managers 402-404, and 410-416 shown in FIG. 4 may also represent all or portions of one or more special purpose computers to perform one or more operations.

As mentioned above, and as shown in FIG. 4, the speculative planning application 110 includes the I/O manager 402. In one or more embodiments, the I/O manager 402 generates the graphical user interface 302 and displays planning outputs received from the speculative planning system 102 via the graphical user interface 302. In one or more embodiments, the I/O manager 402 also detects user inputs via the graphical user interface 302 and packages the detected user inputs for transmittal to the speculative planning system 102.

As mentioned above, and as shown in FIG. 4, the speculative planning application 110 also includes the client communication manager 404. In one or more embodiments, the client communication manager 404 communicates with the speculative planning system 102 to receive planning outputs and provide user inputs detected via the graphical user interface 302.

As mentioned above, in some embodiments, the client computing device 108 includes a web browser 406. In one or more implementations, the speculative planning application 110 operates as a plugin to the web browser. Alternatively, in some implementations, the user of the client computing device 108 can interact with the speculative planning system 102 directly via a website accessed through the web browser 406.

As mentioned above, the speculative planning system 102 includes the communication manager 410. In one or more embodiments, the communication manager 410 communicates with the LLM approximation agent 104, the LLM target agent 106, and the client computing device 108. For example, the communication manager 410 can initiate calls to the LLM approximation agent 104 and the LLM target agent 106. The communication manager 410 can further receive those planning outputs from the LLM approximation agent 104 and the LLM target agent 106. The communication manager 410 also communicates planning outputs to the speculative planning application 110 and receives detected user inputs from the speculative planning application 110.

As mentioned above, the speculative planning system 102 includes the agent manager 412. In one or more embodiments, the agent manager 412 configures calls for the LLM approximation agent 104 and the LLM target agent 106 based on prefixes (e.g., action trajectories). Additionally, the agent manager 412 can compare planning outputs of the LLM approximation agent 104 and the LLM target agent 106 to determine whether corresponding planning outputs match. In one or more embodiments, the agent manager 412 can further halt operation of the LLM approximation agent 104 and/or the LLM target agent 106—or process threads of the LLM approximation agent 104 and/or the LLM target agent 106—based on the outcomes of those match determinations. Furthermore, the agent manager 412 can restart the LLM approximation agent 104 and/or the LLM target agent 106 based on updated prefixes, action trajectories, and/or user inputs.

As mentioned above, the speculative planning system 102 includes the display manager 414. In one or more embodiments, the display manager 414 generates the graphical user interface 302 for display on the client computing device 108 and updates the graphical user interface 302 based on planning outputs. In at least one embodiment, the display manager 414 further reschedules the planning outputs as discussed above with reference to FIGS. 3A and 3B to ensure that displayed planning outputs are both relevant and in-order.

As mentioned above, the speculative planning system 102 includes the action manager 416. In one or more embodiments, the action manager 416 handles step actions that are determined and confirmed by the speculative planning process in order to complete a requested task. Generally, planning a step is more computationally intensive than performing the step. As such, the time it takes the action manager 416 to execute an action indicated by a confirmed planning output (e.g., “verify B's account”) is a fraction of the time it takes the LLM approximation agent 104 and the LLM target agent 106 to actually confirm the planning output. In one or more implementations, the action manager 416 can reformat a confirmed planning output into an expected syntax and apply a machine learning model or other algorithm to the reformatted planning output to complete the step.

As further shown in FIG. 4, the speculative planning system 102 can include additional items 420. In one or more embodiments, the additional items 420 can include data utilized by the speculative planning system 102 in performing speculative planning. For example, the additional items 420 can include training data for the LLM approximation agent 104 and/or the LLM target agent 106. The additional items 420 can also include historical data such as planning outputs previously generated for past tasks. In some embodiments, the speculative planning system 102 can leverage the additional items 420 for analysis and further training of the LLM approximation agent 104 and/or the LLM target agent 106.

In one or more embodiments, the client computing device 108 and the server(s) 401 include one or more memories and one or more physical processors (e.g., such as processors 408, 418 respectively). For example, the one or more memories can generally represent any type or form of volatile or non-volatile storage device or medium capable of storing data and/or computer-readable instructions. In one example, the one or more memories may store, load, and/or maintain one or more components of the speculative planning system 102. Examples of the one or more memories can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Additionally, the one or more physical processors (e.g., the processor(s) 408, 418) can generally represent any type or form of hardware-implemented processing units capable of interpreting and/or executing computer-readable instructions. In one implementation, the one or more physical processors may access and/or modify one or more components of the speculative planning system 102. Examples of the one or more physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As mentioned above, FIG. 5 illustrates an example series of acts 500 related to using a generative AI model to concurrently perform a plurality of steps of a task using a generative AI model to concurrently perform a plurality of steps of a task. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device to perform the acts of FIG. 5. In still further embodiments, a system can perform the acts of FIG. 5.

As illustrated in FIG. 5, the series of acts 500 includes an act 510 of applying an approximation agent of the generative AI model to the task to generate a first approximation planning output for a first step of the plurality of steps of the task applying an. For example, the approximation agent can include a single thread that operates sequentially. Additionally, in one or more embodiments, the task is a text-based input, the first approximation planning output is a text-based step to complete the task, and the first target planning output is a text-based step to complete the task.

As further illustrated in FIG. 5, the series of acts 500 includes an act 520 of applying a target agent of the generative AI model to the task to generate a first target planning output for the first step of the plurality of steps of the task. For example, the target agent can include multiple threads that operate asynchronously. In at least one embodiment, the series of acts 500 further includes applying a hyperparameter to a sequential operation of the approximation agent that prevents the approximation agent from generating more than a predetermined number of approximation planning outputs without determining that at least one of the predetermined number of approximation planning outputs matches to at least one target planning output. In some embodiments, the approximation agent is a large language model and the target agent is a large language.

The series of acts 500 further includes an act 530 of determining whether the first approximation planning output and the first target planning output match. For example, determining that the first approximation planning output and the first target planning output match can include at least one of: determining that there is a string match between the first approximation planning output and the first target planning output, or determining that a threshold number of tokens match between the first approximation planning output and the first target planning output.

The series of acts 500 also includes an act 540 of, when the first approximation planning output and the first target planning output match: applying the target agent to the task utilizing the first approximation planning output as a prefix to generate a second target planning output for a second step of the plurality of steps of the task, and continuing to apply the approximation agent to the task to generate a second approximation planning output for the second step of the plurality of steps of the task. For example, determining that the first approximation planning output and the first target planning output match can include at least one of: determining that there is a string match between the first approximation planning output and the first target planning output, or determining that a threshold number of tokens match between the first approximation planning output and the first target planning output. The series of acts 500 also includes an act 540 of, when the first approximation planning output and the first target planning output match: applying the target agent to the task utilizing the first approximation planning output as a prefix to generate a second target planning output for a second step of the plurality of steps of the task, and continuing to apply the approximation agent to the task to generate a second approximation planning output for the second step of the plurality of steps of the task.

Moreover, the series of acts 500 includes an act 550 of, when the first approximation planning output and the first target planning output do not match: halting the approximation agent, and restarting the approximation agent by inputting the first target planning output of the target agent as the prefix to the approximation agent to generate the second approximation planning output for the second step of the plurality of steps of the task.

It will be appreciated that acts 540-550 may be performed as alternative acts with respect to a determination of whether the first approximation planning output and the first target planning output match or do not match. For example, in one or more embodiments, the act 540 is performed based on a determination that the respective outputs match. Alternatively, in one or more embodiments, the act 550 is performed based on a determination that the respective outputs do not match.

In one or more embodiments, the series of acts 500 includes additional acts. For example, in one or more embodiments, the series of acts 500 includes applying the LLM target agent to the task to generate a second target planning output for the second step of the task prior to determining whether the first approximation planning output and the first target planning output match, determining whether the second approximation planning output and the second target planning output match, when the second approximation planning output and the second target planning output match: applying the target agent to the task utilizing the second approximation planning output as a prefix to generate a third target planning output for a third step of the plurality of steps of the task, and concurrently applying the approximation agent to the task to generate a third approximation planning output for the third step of the plurality of steps of the task, and when the second approximation planning output and the second target planning output do not match: halting the approximation agent, and restarting the approximation agent by inputting the second target planning output of the target agent as the prefix to the approximation agent to generate the third approximation planning output for the third step of the plurality of steps of the task. In one or more embodiments, the series of acts 500 includes in response to the approximation agent generating the third approximation planning output for the third step of the plurality of steps of the task, applying a new thread of the target agent to the task utilizing the third approximation planning output as a prefix to generate a fourth target planning output prior to a previous thread of the target agent generating the third target planning output for the third step of the plurality of steps of the task.

Furthermore, in some embodiments, the series of acts 500 includes generating a graphical user interface for displaying the first approximation planning output and the first target planning output on a client device. For example, generating the graphical user interface can include determining whether the first approximation planning output is irrelevant, and displaying the first approximation planning output within the graphical user interface based on the determination. Additionally, generating the graphical user interface can include rescheduling approximation planning outputs and target planning outputs to display the approximation planning outputs and the target planning outputs in a correct order.

In some implementations, the series of acts 500 further includes detecting user input via the graphical user interface in response to the displayed first approximation planning output and prior to displaying the first target planning output. For example, the series of acts 500 can include, in response to detecting the user input: halting the target agent, and restarting the target agent based on the user input. Additionally, the series of acts 500 can include, in response to determining that the user input agrees with the first approximation planning output: halting the approximation agent and the target agent, and restarting the approximation agent and the target agent based on the user input.

FIG. 6 illustrates certain components that may be included within a computer system 600. One or more computer systems 600 may be used to implement the various devices, components, and systems described herein.

The computer system 600 includes a processor 601. The processor 601 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for using a generative AI model to concurrently perform a plurality of steps of a task, the method comprising:
applying an approximation agent of the generative AI model to the task to generate a first approximation planning output for a first step of the plurality of steps of the task;
concurrently applying a target agent of the generative AI model to the task to generate a first target planning output for the first step of the plurality of steps of the task;
determining whether the first approximation planning output and the first target planning output match;
when the first approximation planning output and the first target planning output match:
applying the target agent to the task utilizing the first approximation planning output as a prefix to generate a second target planning output for a second step of the plurality of steps of the task, and
continuing to apply the approximation agent to the task to generate a second approximation planning output for the second step of the plurality of steps of the task; and
when the first approximation planning output and the first target planning output do not match:
halting the approximation agent, and
restarting the approximation agent by inputting the first target planning output of the target agent as the prefix to the approximation agent to generate the second approximation planning output for the second step of the plurality of steps of the task.

2. The method as recited in claim 1, wherein the approximation agent comprises a single thread that operates sequentially and the target agent comprises multiple threads that operate asynchronously.

3. The method as recited in claim 1, wherein the task is a text-based input, the first approximation planning output is a text-based step to complete the task, and the first target planning output is a text-based step to complete the task.

4. The method as recited in claim 1, further comprising:
determining whether the second approximation planning output and the second target planning output match;
when the second approximation planning output and the second target planning output match:
applying the target agent to the task utilizing the second approximation planning output as a prefix to generate a third target planning output for a third step of the plurality of steps of the task, and
continuing to apply the approximation agent to the task to generate a third approximation planning output for the third step of the plurality of steps of the task; and
when the second approximation planning output and the second target planning output do not match:
halting the approximation agent, and
restarting the approximation agent by inputting the second target planning output of the target agent as the prefix to the approximation agent to generate the third approximation planning output for the third step of the plurality of steps of the task.

5. The method as recited in claim 4, further comprising, in response to the approximation agent generating the third approximation planning output for the third step of the plurality of steps of the task, applying a new thread of the target agent to the task utilizing the third approximation planning output as a prefix to generate a fourth target planning output prior to a previous thread of the target agent generating the third target planning output for the third step of the plurality of steps of the task.

6. The method as recited in claim 5, further comprising applying a hyperparameter to a sequential operation of the approximation agent that prevents the approximation agent from generating more than a predetermined number of approximation planning outputs without determining that at least one of the predetermined number of approximation planning outputs matches at least one target planning output.

7. The method as recited in claim 1, wherein determining that the first approximation planning output and the first target planning output match comprises at least one of:
determining that there is a string match between the first approximation planning output and the first target planning output; or
determining that a threshold number of tokens match between the first approximation planning output and the first target planning output.

8. The method as recited in claim 1, wherein the approximation agent is a first large language model (LLM) based agent and the target agent is a second LLM based agent.

9. A system comprising:
at least one processor:
memory in electronic communication with the at least one processor; and
instructions stored in memory, the instructions being executable by the at least one processor to:
apply an approximation agent of a generative AI model to a task comprising a plurality of steps to generate a first approximation planning output for a first step of the plurality of steps of the task;
concurrently apply a target agent of the generative AI model to the task to generate a first target planning output for the first step of the plurality of steps of the task;
determine whether the first approximation planning output and the first target planning output match;
when the first approximation planning output and the first target planning output match:
apply the target agent to the task utilizing the first approximation planning output as a prefix to generate a second target planning output for a second step of the plurality of steps of the task, and
continue to apply the approximation agent to the task to generate a second approximation planning output for the second step of the plurality of steps of the task; and
when the first approximation planning output and the first target planning output do not match:
halt the approximation agent, and
restart the approximation agent by inputting the first target planning output of the target agent as the prefix to the approximation agent to generate the second approximation planning output for the second step of the plurality of steps of the task.

10. The system as recited in claim 9, further comprising generating a graphical user interface for displaying the first approximation planning output and the first target planning output on a client device.

11. The system as recited in claim 10, wherein generating the graphical user interface comprises:
determining whether the first approximation planning output is irrelevant; and
based on determining whether the first approximation planning output is relevant, displaying the first approximation planning output within the graphical user interface.

12. The system as recited in claim 10, wherein generating the graphical user interface comprises rescheduling approximation planning outputs and target planning outputs to display the approximation planning outputs and the target planning outputs in a correct order.

13. The system as recited in claim 10, further comprising detecting user input via the graphical user interface in response to the displayed first approximation planning output and prior to displaying the first target planning output.

14. The system as recited in claim 13, further comprising, in response to detecting the user input:
halting the target agent, and
restarting the target agent based on the user input.

15. The system as recited in claim 13, further comprising, in response to determining that the user input agrees with the first approximation planning output:
halting the approximation agent and the target agent, and
restarting the approximation agent and the target agent based on the user input.

16. A method for speculatively planning a task comprising a plurality of steps, the method comprising:
applying an LLM approximation agent to a task to generate a first approximation planning output for a first step of the plurality of steps of the task;
applying an LLM target agent to the task to generate a first target planning output for the first step of the plurality of steps of the task;
determining whether the first approximation planning output and the first target output match;
when the first approximation planning output and the first target planning output match:
applying the LLM target agent to the task utilizing the first approximation planning output as a prefix to generate a second target planning output for a second step of the plurality of steps of the task, and
continuing to apply the LLM approximation agent to the task to generate a second approximation planning output for the second step of the plurality of steps of the task; and
when the first approximation planning output and the first target planning output do not match:
halting the LLM approximation agent; and
restarting the LLM approximation agent by inputting the first target planning output of the LLM target agent as the prefix to the LLM approximation agent to generate the second approximation planning output for the second step of the plurality of steps of the task.

17. The method of claim 16, wherein the LLM approximation agent comprises a single thread that operates sequentially.

18. The method of claim 16, wherein the LLM target agent comprises multiple threads that operate asynchronously.

19. The method of claim 16, wherein the task is a text-based input, the first approximation planning output is a text-based step to complete the task, and the first target planning output is a text-based step to complete the task.

20. The method of claim 16, further comprising:
determining whether the second approximation planning output and the second target planning output match;
when the second approximation planning output and the second target planning output match:
applying the LLM target agent to the task utilizing the second approximation planning output as a prefix to generate a third target planning output for a third step of the plurality of steps of the task, and
continuing to apply the LLM approximation agent to the task to generate a third approximation planning output for the third step of the plurality of steps of the task; and
when the second approximation planning output and the second target planning output do not match:
halting the LLM approximation agent; and
restarting the LLM approximation agent by inputting the second target planning output of the LLM target agent as the prefix to the LLM approximation agent to generate the third approximation planning output for the third step of the plurality of steps of the task.
